(19) United States
(12) Patent Application Publication
(10) Pub. No.: US 2009/0110772 A1
(43) Pub. Date: Apr. 30, 2009

(54) WATER SOLUBILIZATION OF CELLULOSICS AND RELATED COMPOUNDS

(75) Inventors: John G. VERKADE, Ames, IA (US); Reed E. OSHEL, Overland Park, KS (US)

Correspondence Address: NIXON PEABODY LLP - PATENT GROUP, 1100 CLINTON SQUARE, ROCHESTER, NY, 14604, US

(73) Assignee: IOWA STATE UNIVERSITY RESEARCH FOUNDATION, INC., Ames, IA (US)

(21) Appl. No.: 11/923,435

(22) Filed: Oct. 24, 2007

(51) Int. Cl. C13K 1/06; C08B 30/00; C13F 3/00

(52) U.S. Cl. 426/48; 127/34; 127/30

(57) ABSTRACT

The present invention is directed toward a method of solubilizing melaninic, ligninic, chitinic, and/or cellulosic material. The method includes providing melaninic, ligninic, chitinic, and/or cellulosic material and providing an oxoacid ester of phosphorus or a mixture of an oxoacid of phosphorus and an alcohol. A blend of the melaninic, ligninic, chitinic, and/or cellulosic material, the oxoacid ester of phosphorus or the mixture of the oxoacid of phosphorus and alcohol is formed. The blend is then treated under conditions effective to solubilize the melaninic, ligninic, chitinic, and/or cellulosic material.

The subject matter of this application was made with support from the United States Government under Department of Energy, Grant No. W-7405-ENG-82. The U.S. Government has certain rights.

### FIELD OF THE INVENTION

The present invention relates to water solubilization of cellulosic and related materials including melanic, ligninic, and chitinic materials.

### BACKGROUND OF THE INVENTION

Methods for the degradation of cellulosic materials to oligosaccharides and sugar alcohols aimed at facilitating ethanol production, continue to be the subject of wide and intense interest. Such methods include cellulose treatment with enzymes, mainly cellulases and hemicellulases (Demain, A. L., et. al., Microbiol. Molec. Biol. Rev. 69: 124 (2005); Fan, L. T., et. al., Cellulose Hydrolysis, Springer, Berlin (1987); Zhang, Y. P., et al., Biotechnol. Bioeng., 88: 797 (2004)), mineral acids (Mok. W. S., et. al., Ind. Eng. Chem. Res., 31: 94 (1992)), bases (Ishida, M., et. al., J. Chem. Technol. Biotechnol., 80: 281(2005)), supercritical water (Sasaki, M., et. al., Ind. Eng. Chem. Res. 39: 2883 (2000)), hot water in the presence of a strongly acidic cation exchange resin (Kim, Y. M., et. al., BIOT-323, Abstracts of Papers, 225^{th} ACS national Meeting, New Orleans, La., Mar. 23-27(2003); and Ladisch, M. R., et. al., AGFD-103, Abstracts of Papers, 225^{th} ACS national Meeting, New Orleans, La., Mar. 23-27, 2003), hot water solutions of lanthanide salts (Sakaki, T., et al., 2002, Jpn. Kokai Tokkyo Koho, JP 2002085100, CAN 136:246813, and, more recently, platinum or ruthenium-supported catalysts that accomplish conversion to sugars (Fukuoka, A., et. al., Angew. Chem. Int. Ed,. 45: 5161(2006)).

Approaches to simple disruption of the hydrogen bonds in cellulose have also been described. Examples include hot water treatment (Kobayashi, N., et. al., World Congress of Chemical Engineering, 7^{th}, Glasgow, United Kingdom, Jul. 10-14, 2005), pH controlled hot water treatment (Mosier, N., et. al., Biores. Technol., 96: 6, 673-686 (2005); and Mosier, N. S., et. al., Appl. Biochem. & Biotech., 125: 77-85 (2005)), extrusion/explosion processing of ammonia-impregnated fibers (AFEX) (Dale, B. E., et. al., Appl. Biochem. Biotechnol. 77-79 (1999); and Liu, N., et. al., “Research Progress of Converting Lignocellulose to Produce Fuel Ethanol”, 25: 3, 19-22 (2005), steam explosion (Sun, X. F., et. al., Carbohyd. Res., 340: 97-106 (2005); Josefsson, T., et. al., Holzforsch, 56: 3, 289-297(2002); Jain, R. K., et. al., CELL-041, Book of Abstracts, 218^{th} ACS National Meeting, New Orleans, Aug. 22-26, 1999; and Wu, M. M., et. al., Appl. Biochem. Biotechnol., 77-79 (1999)), ultrasound treatment (Yang, K., et al., Biotechnol. Prog., 20:1053 (2004)), and dissolution in ionic liquids (Zhu, S., et al., Green Chem. 8: 325 (2006)). The use of mixtures of electron-donor solvents with nitrogen oxides, lithium chloride, triethylamine oxide, methylmorpholine oxide, trifluoroacetic acid, orthphosphoric acid, and aqueous solutions of zinc chloride for dissolving cellulose, has been reviewed (see Grinshpan, D. D. B., “Novel Processes for Production and Processing of Cellulose Solutions”, Editor: Sviridov, B. B. Khimicheskie Problemy Sozdaniya Novykh Materialov I Tekhnologii, 87, Belorusskii Gosudarstvennyi Universitet, Minsk (1998)).

In addition to dissolution of cellulosic materials in some of the aforementioned media, some chemical derivatization can and probably does occur, as in the cases of trifluoroacetic and orthphosphoric acids to form trifluoroacetate and phosphate esters, respectively. Dissolving cellulose in an acid anhydride can lead to regioselectively functionalized polymers (El Seoud, O. A., et. al., Adv. Polymer Sci., 186: 103 (2005)), and regioselective esterification and etherification of glucose has been demonstrated to influence the processing and use of these products (Burkart, P., et. al., Polym. News, 21: 155 (1996)). The synthesis of cellulose sulfonates (e.g., tosylates and mesylates) provides polymers with interesting properties as well as intermediates to new cellulosic products (Siegmund, G., et. al., Polym. News, 27: 84 (2002)). Fatty acid esters of cellulose lead to novel bioplastics and films (Song, L., et. al., Gaofenzi Cailiao Kexue Yu Gongcheng, 18: 11 (2002); and Satge, C., et. al., Comptes Rendus Chimie, 7:135 (2004)). Such esters also open new synthetic possibilities for introducing functional groups into cellulose providing pathways to cellulose esters and ethers and their derivatives, as well as biologically active molecules covalently bound to cellulose (Bojanic, V., et. al., Hemisjska Industrija, 52:191(1998)). The reaction kinetics of the production of cellulose ethers (e.g., methyl, hydroxyethylmethyl and hydroxyethyl) have also been reviewed (see Doenges, R., Brit. Polym. J., 23: 315-26 (1991).

As a percentage of the approximately 89% dry matter in Distillers Dry Grains and Solubles (DDGS) obtained from Big River Resources, LLC, Burlington, Iowa, cellulose and starch (polyglucoses) comprise ca 16 and 5%, respectively, and the hemicelluloses (polypentoses) xylan, and arabinan comprise a total of about 13.5%. (see Kim, Y.,et al., “Composition of Corn Dry-Grind Ethanol By-Products: DDGS, Wet Cake, and Thin Stillage”, Biores. Technol., in press (2007); Kim, Y., et al., “Enzyme Hydrolysis and Ethanol Fermentation of Liquid Hot Water (LHW) and AFEX Pretreated Distiller's Grains at High Solids Loadings”, Biores. Technol., in press (2007); and Kim, Y., et al., “Process Simulation of Modified Dry Grind Ethanol Plant with Recycle of Pretreated and Enzymatically Hydrolyzed Distiller's Grains”, Biores. Technol., in press (2007)).

None of these polysaccharides have appreciable solubility in water, and so it is desirable to develop reasonably mild methods for degrading and/or derivatizing these materials in such a way as to solubilize them in water, since water is the solvent of choice for the commercial production of ethanol by enzymatic means. Thus, water solubilization of these polysaccharides and heteropolysaccharides facilitate access to them by cellulases and fermentation enzymes. A recent review (Mosier, N., et. al., Biores. Technol., 96(6): 673-686 (2005)) describes desired traits in a pretreatment, including its effect on biomass surface area, cellulose crystallinity, and hemicellulose and lignin processability. A review of current pretreatment technologies is also given (Mosier, N. S., et. al., Appl. Biochem. & Biotechnol., 125: 77-85 (2005)). A coordinated effort to develop leading pretreatment technologies was also reported (Wyman C. E., et al., Biores. Technol., 96: 1959-1966 (2005)).

Phosphitylation has been developed in recent years as a technique for derivatizing carbohydrates, nucleosides, and nucleotides (Dabkowski, W., Chem. Nucl. Acid Comp.: Collect. Symp. Series, 7: 39-46 (2005); Dabkowski, W., et. al., N. J. Chem., 29: 11 (2005); Laneman, Scott A., Spec. Chem. Mag., 25(1): 30-32 (2005); Ahmadibeni, Y., et. al., J. Org. Chem., 70(3): 1100-1103 (2005); Oka, N., et. al., J. Am. Chem. Soc., 125(27): 8307-8317 (2003); and Parang, K., et. al., Org. Letters, 3(2): 307-309 (2001), although this technique has been known longer for simple alcohols (Dabkowski, W., Chem. Nucl. Acid Comp.: Collect. Symp. Series, 7: 39-46 (2005); Dabkowski, W., et. al., N. J. Chem., 29: 11 (2005); and Watanabe, Y., et. al., Tetrahed. Letters, 31(2): 255-6 (1990)).

The present invention is directed to overcoming these and other deficiencies in the art.

### SUMMARY OF THE INVENTION

One aspect of the present invention is directed toward a method of solubilizing melaninic, ligninic, chitinic, and/or cellulosic material. The method includes providing melaninic, ligninic, chitinic, and/or cellulosic material and providing an oxoacid ester of phosphorus or a mixture of an oxoacid of phosphorus and an alcohol. A blend of the melaninic, ligninic, chitinic, and/or cellulosic material and the oxoacid ester of phosphorus or the mixture of the oxoacid of phosphorus and alcohol is formed. The blend is then treated under conditions effective to solubilize the melaninic, ligninic, chitinic, and/or cellulosic material.

Another aspect of the present invention is directed toward a composition comprising solubilized organophosphorous ester derivatives of melaninic, ligninic, chitinic, and/or cellulosic material.

A further aspect of the present invention is directed toward a hydrolysis method. The method includes providing the composition as described above and providing an enzyme. The composition is treated with the enzyme under conditions effective to hydrolyze the composition.

A still further aspect of the present invention is directed toward a fermentation method. The method includes providing the composition as described above and providing a fermentation agent. The composition is treated with the the fermentation agent under conditions effective to ferment the composition.

An advantage of the present invention is that the solvent systems described provide high solubilities of lignocellulosic feedstocks in methanol and in water. The variety of such feedstocks include herbaceous, woody and manufactured cellulosic materials. A second advantage is that in addition to the solvent action, there is also a chemical reaction of the solvent with glycoside bonds which chemically cleaves the polymeric species into smaller fragments. Other substances that are highly solubilized include lignin and melanin.

### BRIEF DESCRIPTION OF THE DRAWINGS

FIGS. 1A-B show reaction schemes of Reaction 1 (FIG. 1A) and Reaction 2 (FIG. 1B) of phosphite esters with alcohol or carbohydrate hydroxyl groups.

FIG. 2 shows structural representations of phosphite esters 1-4, phosphonates 5 and 6, and potential products 7 and 8.

FIG. 3 illustrates the concept of phosphite treatment.

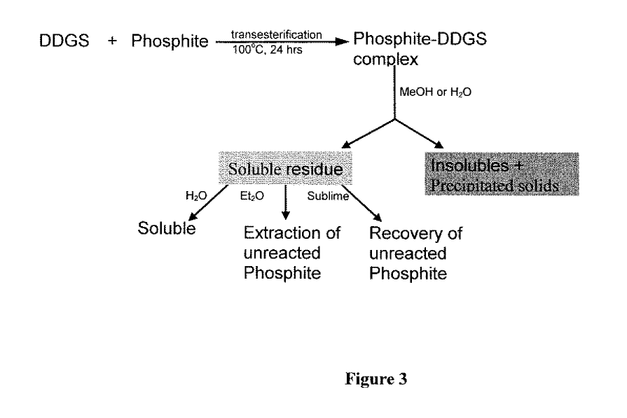

FIG. 4 shows structural representations of tautomer, isomer, and conformations in hydrogen phosphonates.

FIG. 5 shows proposed mechanism for phosphonate cleavage of glycosidic bonds in cellulose by either a stepwise or a concerted reaction.

### DETAILED DESCRIPTION OF THE INVENTION

One aspect of the present invention is directed toward a method of solubilizing melaninic, ligninic, chitinic, and/or cellulosic material. The method includes providing melaninic, ligninic, chitinic, and/or cellulosic material and providing an oxoacid ester of phosphorus or a mixture of an oxoacid of phosphorus and an alcohol. A blend of the melaninic, ligninic, chitinic, and/or cellulosic material and the oxoacid ester of phosphorus or the mixture of the oxoacid of phosphorus and alcohol is formed. The blend is then treated under conditions effective to solubilize the melaninic, ligninic, chitinic, and/or cellulosic material.

In certain embodiments, the oxoacid ester of phosphorus is provided. In some embodiments, the mixture of the oxoacid of phosphorus and the alcohol is provided. The melaninic, ligninic, chitinic, and/or cellulosic material may be fully solubilized or may be partially solubilized as a result of the treating.

In certain embodiments, the melaninic, ligninic, chitinic, and/or cellulosic material is lignocellulosic material. Suitable lignocellulosic materials include wood fiber, vegetable fiber, or mixtures thereof. In certain embodiments, the melaninic, ligninic, chitinic, and/or cellulosic material may be ligninic material.

The treating step may be carried out at a temperature of 60-150° C., preferably at a temperature of 75-110° C.

The oxoacid ester of phosphorus may be an ester of phosphorous acid, phosphoric acid, hypophosphorous acid, polyphosphoric acid, or mixtures thereof.

The oxoacid of phosphorus may be phosphorous acid, phosphoric acid, hypophosphorous acid, polyphosphoric acid, or mixtures thereof.

Suitable alcohols include methanol, ethanol, ethylene glycol, propylene glycol, glycerol, pentaerythritol, trimethylol ethane, trimethylol propane, trimethylol alkane, alkanol, polyol, or mixtures thereof.

The blend may have a ratio of the oxoacid of phosphorus to the alcohol of from 10:1 to 1:10.

The method of the present invention can include regulating the water content of the blend during treating. Regulation of the water content can be carried out by removing water. Suitable techniques for doing so include molecular sieving, distillation, or adding a dehydrating agent to the blend.

The method of the present invention may further include adding an enzyme to the blend after the treating. Useful enzymes include cellulases, such as cellulases for saccharification.

The method of the present invention may also include sonicating the blend during or after the treating.

A fermentation agent may be added to the blend after the treating step. The fermentation agent, for example, may be a yeast. In carrying out this aspect of the present invention, soluble monosaccharides, oligosaccharides, polysaccharides, heteropolysaccharides, and/or sugar alcohols can be fermented in the blend after the treating.

Another aspect of the present invention is directed toward a composition comprising solubilized organophosphorous ester derivatives of melaninic, ligninic, chitinic, and/or cellulosic material.

A further aspect of the present invention is directed toward a hydrolysis method. The method includes providing the composition as described above and providing an enzyme. The composition is treated with the enzyme under conditions effective to hydrolyze the composition. Useful enzymes include cellulases, such as cellulases for saccharification.

A still further aspect of the present invention is directed toward a fermentation method. The method includes providing the composition as described above and providing a fermentation agent. The composition is treated with the fermentation agent under conditions effective to ferment the composition. The fermentation agent, for example, may be a yeast.

The value-added products currently generally associated with lignocellulose conversion are ethanol and butanol. However, cellulose conversion can also produce lactic acid, fatty acids, xylitol, acid hydrolysis products such as furfural and levulinic acid, chemical conversion products such as gluconic acid, sorbitol, mannitol, cellulose derivatives (e.g., cellulose acetate), CO, and hydrogen.

The method of the present invention is useful in treating Distillers Dry Grains and Solubles (DDGS) and other materials which renders the water-soluble product suitable, for example, for digestion in animal feed and/or to enzymatic hydrolysis to enzymatically fermentable sugars for ethanol production after minimal neutralization with base.

Transesterification can be driven by the release of a more volatile alcohol as in reaction 1 (below), where R is larger than an ethyl group. However, it has been observed that phosphite esters are also capable of dissolving cellulosic materials to varying degrees (depending on the source) via conversion of at least some of the hydroxyl groups to phosphite ester groups in a phosphitylation reaction (e.g., reaction 2, below).

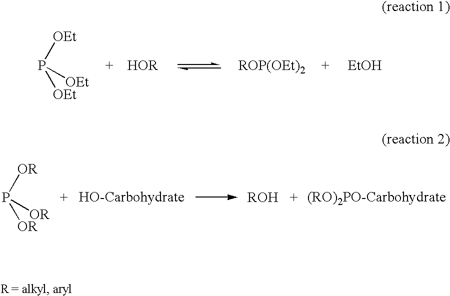

There are two independent variables at work in the technology, namely, biomass solubility and the degree of glycoside bond cleavage in the polysaccharide chains. The first depends in large measure on how well the phosphite ester system disrupts the relatively weak intrachain hydrogen bonding interactions that cause aggregation of the polysaccharide chains to form insoluble bundles, and the second depends on how well the phosphite ester system cleaves interchain strong glycosidic chemical bonds for better cellulase enzyme access. The technology under harsher conditions would not only disrupt the intrachain interactions, but might also completely saccharify the chains by breaking the vast majority if not all of the glycosidic linkages. As a result, the need for cellulase enzymes which are a costly and major barrier in more economical ethanol production is eliminated. The harsher conditions proposed will be generated by employing high-power sonication, a technique increasingly used in industry. Evidence from work on DDGS suggests that glycoside bonds are cleaved to some extent just on heating and this breakdown could provide more rapid cellulase enzyme action.

It is well known that hydrolysis equilibria are reversible for many chemicals, phosphite esters are no exceptions (see Scheme 1 for an example). Thus, this process can proceed from left to right in each equilibrium step starting with P(OEt)₃ and water, or from right to left starting from phosphorous acid and ethanol at the lower right of the Scheme. Starting with 3 equivalents of EtOH and an equivalent of phosphorous acid and then removing the water (e.g., with molecular sieves) produces mainly P(OEt)₃.

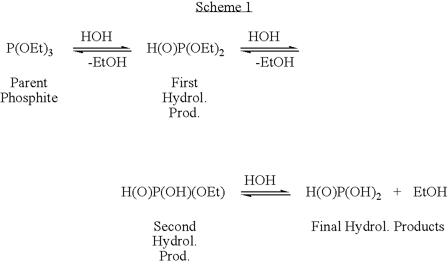

It is possible to start with phosphorous acid and the required alcohol to make a mixture of the first hydrolysis product and the second hydrolysis product for use as the active pretreatment medium or to start with the first hydrolysis product, and by adding the correct amount of water, make the same mixture as starting with phosphorous acid and the required alcohol.

It is generally possible to proceed in either direction of an equilibrium or sequence of equilibria. This process is governed by Le Chatelier's Principle.

It has been shown that the non-toxic first and second hydrolysis products of the toxic bicyclic phosphite P(OCH₂)₃CEt are the active species for effectively solubilizing a wide range of lignocellulosics (e.g., cellulose itself, corn stover, pine and poplar shavings, kenaf, and Distillers Dry Grains and Solubles (DDGS, which comes from the dry mill corn-to-ethanol process).

The alcohols (see Table 1, below) from which A, (ethanol), B (ethylene glycol), C (propylene glycol), and D (2,2-dimethylpropylene-1,3-diol) are commercially inexpensive, are manufactured in large volumes, and are of very considerable industrial importance.

TABLE 1
H(O)P(OEt)₂
A

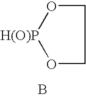

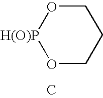

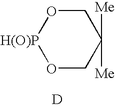

EtOP(OEt)₂
E

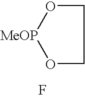

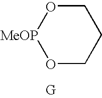

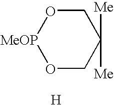

H(O)POH(OEt)
I

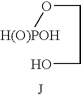

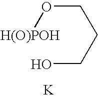

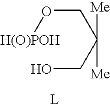

In Schemes 2, 3, and 4 (below), the polyols from which N, R, and V in these schemes are made are glycerol, trimethylol propane, and pentaerythritol, respectively (see Table 1, above). These polyols are very cheap and are made in large volumes (i.e. glycerol is an overly abundant byproduct of the biodiesel industry, trimethylol propane is used in polyurethane manufacture, and pentaerythritol is made in over 100 million pound quantities per year, most of which is used in alkyd resins and lubricants). Although the parent bicyclic phosphite M in Scheme 2 is known, it would not form in the proposed reaction of glycerol and phosphorous acid, because of its strained bonds and the fact that its formation would require the presence of a catalyst. A catalyst is also required for the analogous formations of the toxic parent phosphite Q in Scheme 3 and the non-toxic parent phosphite U shown in Scheme 4. It should be noted that neither first nor second hydrolysis products for the phosphite esters in Schemes 2-4 are commercially available and there are no reports of their isolation to date.

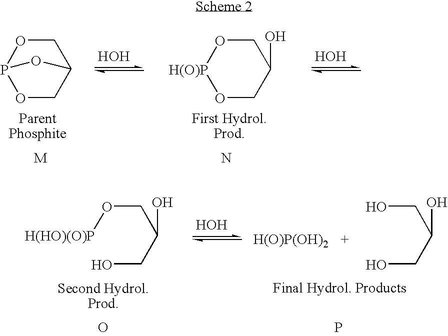

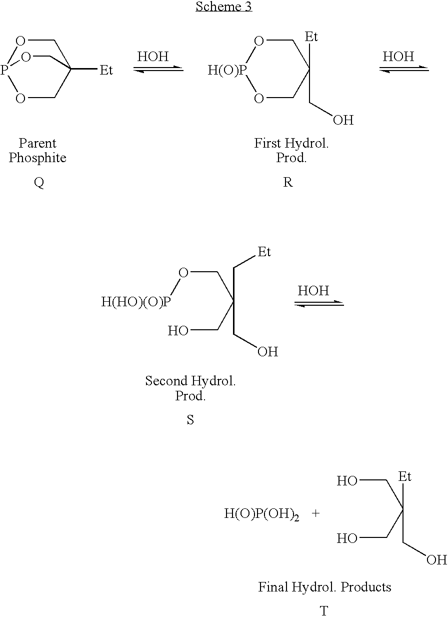

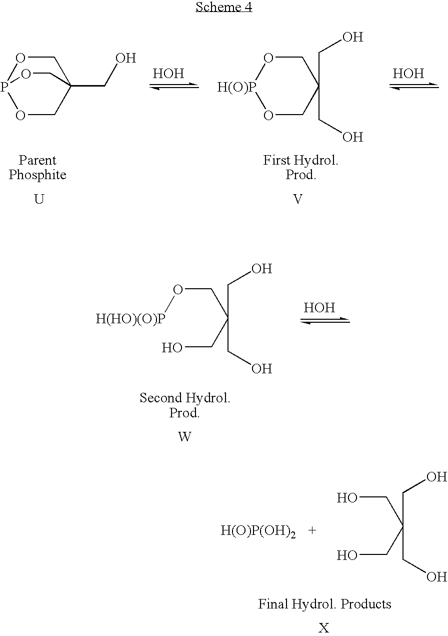

Synthesis of parent phosphite esters for subsequent hydrolysis (to make the desired ratio of first to second hydrolysis products) requires expense, time and energy, which can be avoided by starting with phosphorous acid and the desired alcohol, diol, triol or tetraol, followed by removing the appropriate amount of water. Note that the parent phosphite esters by themselves are ineffective solubilizing agents. The mixture of active solubilizing agents is created by proceeding from the final hydrolysis products and working toward parent phosphites but not actually synthesizing them.

The first hydrolysis products A-D of the parent phosphites E-H, respectively, are effective solubilizing agents for DDGS. Compounds A, B, and D are commercially available, but C was synthesized. It should be noted that A-D by themselves are also effective in the presence of some water to make a mixture of first and second hydrolysis products I-L.

Melanins are of three main types: 1. Eumelanins, which are black/dark-brown nitrogen-containing pigments; 2. Sulfur-containing pheo-melanin pigments, which result in coloration such as red hair; and 3. Plant phila pigments called allomelanins. The most common form of biological melanin is an oligomer/polymer of either or both indolequinone or dihydroxyindole carboxylic acid as monomeric units. A rare form of melanin is polyacetylene black (found in mushrooms). These materials are robust and are generally very insoluble. Melanins are used in medicine, pharmacology, dermatology, and cosmetics. They also have applications in optics. Synthetic melanin can be synthesized in the laboratory by air oxidation of tyrosine or L-DOPA in the presence of tyrosinase enzymes (obtained from mushrooms).

One skilled in the art would recognize that substitution of a sulfur for one or more oxygens in a phosphorous oxoacid, oxoacid ester, a phosphoric oxoacid, or phosphoric acid ester would be possible as thiophosphorous and thiophosphoric compounds are well known. Such sulfur containing compounds, however, would be more expensive and pose environmental problems.

Ligninic, as used herein, is used to describe compounds comprising or related to the complex polymer lignin. Lignin is the chief noncarbohydrate constituent of wood, that binds to cellulose fibers and hardens and strengthens the cell walls of plants.

### EXAMPLES

### Example 1

### Materials

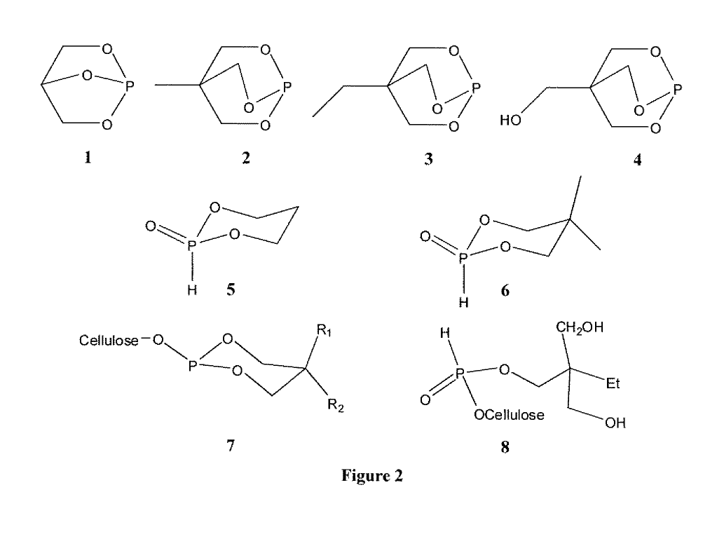

Hot-water treated Distillers Dry Grains and Solubles (HWT-DDGS) was prepared by heating light stillage to 160° C. for 20 minutes. Samples of HWT-DDGS were centrifuged and the solids were separated from the liquid solubles. The recovered water-insoluble solids were then dried under vacuum at 45° C. until free flowing dry solids were obtained. Before treatment with phosphites, the dried HWT-DDGS was ground to 0.5 mm. Extrusion/explosion processed ammonia-impregnated fibers (AFEX) DDGS was provided by Professor Bruce Dale of Purdue University. Lignin was obtained from Westvaco as Indulin AT, a kraft pine lignin polymer. Some of the phosphorus compounds utilized in this study (namely, 1-6) are shown in FIG. 2. Phosphite 1 in this figure was prepared according Denny, et al., Phosphorous and the Related Group V Elements, 2:5-6, 245-8 (1973), which is hereby incorporated by reference in its entirety. Phosphites 2 and 3 in FIG. 2 were also prepared as reported earlier. See Wadsworth, W. S. Jr., et al., J. Am. Chem. Soc., 84: 610-17 (1962), which is hereby incorporated by reference in its entirety. Phosphite 3 was provided by Rhodia. Phosphite 4 was prepared according Pike, R. D., et al., Organometallics, 23: 1986-1990 (2004), which is hereby incorporated by reference in its entirety, as were phosphonates 5 and 6 (see FIG. 2) (see Maffei, M., et al., Tetrahedron, 59: 8821-8825 (2003), which is hereby incorporated by reference in its entirety). Phosphorous acid (99%), (MeO)₃P (99+%), (EtO)₃P (98%), (iPrO)₃P (95%), (PhO)₃P (97%), and (EtO)₂P(O)H (94%) were all purchased from Aldrich Chemical Company and were used as delivered.

### Example 2

### Treatment of HWT-DDGS with 3

HWT-DDGS (250 mg), 3 (7.14 g), and a small octagonal magnetic stir bar were charged to a 20 mL pressure tube. The tube was sealed with a Teflon cap and submersed in a 100° C. oil bath in order to ensure even heating of the tube and its contents and to avoid sublimation of 3 to cooler parts of the tube. The mixture was stirred for 24 hrs and then it was allowed to cool to room temperature whereupon 15 mL of methanol was added. Once all the phosphite and derivatized HWT-DDGS were equilibrated with the methanol, the solids were filtered and weighed.

### Example 3

### Treatment of HWT-DDGS with 3/water

This reaction was carried out as described in Example 2 except that 1 mL (1.25 eq.) of water was also charged to the pressure tube.

### Example 4

### Treatment of HWT-DDGS with Other Phosphites/Phosphonates with and without Water

These treatments were performed as described in Example 2 using 250 mg of HWT DDGS and 44 mmol of the appropriate phosphorus compound. Water (1.25 eq) was added to the phosphorus compound unless otherwise stated.

### Example 5

### Sample Procedure for Microwave Reactions

HWT-DDGS (1 g), 3 (28.6 g), and a magnetic stir bar were charged to an 80 mL reaction vessel and the vessel was placed in a CEM Discover microwave reactor. The conditions employed were 300 W, 130° C., a maximum pressure of 230 psi, and a 6 hr reaction time. After the reaction vessel had cooled and was removed from the reactor, its contents were treated in the same manner as described in Example 2.

### Example 6

### Solubility Studies with Phosphite Esters

A survey of the series of commercially available acyclic phosphite esters P(OMe)₃, P(OEt)₃, P(Oi-Pr)₃ and P(OPh)₃, revealed poor solvent properties at temperatures in excess of 100° C. for HWT-DDGS (and for other cellulosic materials as well) even after prolonged treatment. The bicyclic phosphite esters 1-4 (FIG. 2), however, produced more encouraging results.

Although the reaction of 1 with HWT-DDGS produced no appreciable solubilization and results for 4 revealed poor solubility in the same reaction, both 2 and 3 proved interesting. Compound 4 is not commercially available but 1, 2 and 3 are. The nature of the initial screening experiments with phosphites 2 and 3 deserves comment at this point. Because these phosphites are viscous liquids at their melting points, thus making filtration difficult at best, first qualitative visual estimates were made of how much HWT-DDGS appeared to be solubilized after pretreatment with these phosphite esters. For that purpose a large mass ratio of phosphite to HWT-DDGS was used in a centrifuge tube having a conical bottom in order to enable visual estimation of how much undissolved material remained in the molten phosphite (see Table 2). When HWT-DDGS solubilization occurs, the phosphite changes from clear to yellowish. The solubility in Entry 2 in Table 2 was estimated at approximately 25% reduction in solids by centrifugation of the hot reaction mixture after stirring for 24 hours at 80° C., and the solubility in Entry 4 was estimated at 50% by the same method. From these tests it was determined that 3 was the better medium for solubilizing the HWT-DDGS which exhibited somewhat greater solubility than the AFEX pretreated material. See Table 2 below.

TABLE 2
Screening of pretreated DDGS solubility in 2 and 3^{a}

| Entry | Phosphite | Pretreatment | Solubility observations |
|---|---|---|---|
| 1 | 2 | AFEX | Partial with small decrease in solute |
| | | | mass; slight tint to the phosphite |
| | | | solution |
| 2 | 3 | AFEX | Partial with small decrease in solute |
| | | | mass, but greater than for Entry 1 |
| 3 | 2 | HWT | Mostly soluble; significant decrease in |
| | | | solute mass; distinct coloration of |
| | | | the phosphite solution |
| 4 | 3 | HWT | Mostly soluble; even greater decrease |
| | | | in solute mass than for Entry 3; |
| | | | distinct coloration of the phosphite |
| | | | solution |

^{a}3.5% (w/w) of DDGS (35 mg) in 2 or 3 (1 g) was employed. Each sample was heated at 80° C. for 24 hours.

In order to gain a more quantitative estimate of the solubility of the HWT-DDGS in 3, the reaction in Entry 4 of Table 2 was repeated except that stirring was continued for 48 hours instead of 24 hours. Because the supernatant from the reaction mixture was soluble in methanol, the reaction mixture was extracted with methanol followed by filtration of the remaining solids. The percent solubility was then calculated from equation 1. The solubility of HWT-DDGS in 3 was found to be only 19% (Table 3, entry 1). See Table 3, below. It should be noted that equation 1 does underestimate the amount of HWT-DDGS that solubilized, however, since

[(Initial HWT-DDGS Mass−Remaining DDGS Mass)/Initial HWT−DDGS Mass]×100 (equation 1)

the elemental phosphorus content increases from 0.47% in the HWT-DDGS to 2.28% in the solid material remaining after reaction of the HWT-DDGS with 3. In addition, it was observed in larger scale reactions (ca 1 g of HWT-DDGS and 28.6 g of phosphite) that some precipitation occurred upon methanol extraction. This precipitate, which is presumed to be partially derivatized HWT-DDGS, would add mass to the insolubles and thus further skew the results obtained with equation 1. It should be emphasized here that, to the extent that reactions are occurring between 2 and 3 with cellulosic OH groups, these phosphites are behaving as reactive derivatizing solvents as well as conventional solvating solvents.

TABLE 3
Optimization of HWT-DDGS Solubilization Protocol.^{a}

| | | Lignocellulose | Temp/Energy | % Mass change |
|---|---|---|---|---|
| Entry | Phosphite | solute | source | in solute^{g} |
| 1 | 3 | HWT-DDGS^{b} | 100° C. | −19% |
| 2 | 3 | HWT-DDGS^{b} | μλ | −10% |
| 3 | 4 | HWT-DDGS^{b} | 100° C. | +15% |
| 4 | 3/H₂O^{c} | HWT-DDGS^{b} | 100° C. | −92%^{h} |
| 5 | 3/H₂O^{c} | HWT-DDGS^{b} | 80° C. | −86% |
| 6 | 3/H₂O^{c} | HWT-DDGS^{b} | 150° C. | −99% |
| 7 | 3/H₂O^{c} | HWT-DDGS^{b} | μλ | −74%^{d} |
| 8 | 4/H₂O^{c} | HWT-DDGS^{b} | 100° C. | +750% |
| 9 | 3/H₂O^{c} | AFEX^{b} | 100° C. | −62% |
| 10 | 3/H₂O^{c} | DG^{e} | 150° C. | −99% |
| 11 | 3/H₂O^{f} | HWT-DDGS^{b} | 150° C. | −99% |

^{a}3.5% (w/w) of lignocellulose solute (250 mg) in phosphite (7.14 g) was employed. Samples were heated at 100° C. for 24 hours.
^{b}Ground to 0.5 mm particle size.
^{c}7.14 g phosphite/1 mL (1.25 eq) H₂O
^{d}Phosphite solution turned black and the ³¹P NMR spectrum showed formation of (O)HP(OH)₂.
^{e}Obtained from Big River Resources, LLC and used with out further treatment; water content ca 41%.
^{f}1:1 mol ratio of phosphite to water pre-reacted at 100° C. prior to addition of lignocellulosic material.
^{g}Calculated as the difference in mass of insoluble portions of the solute divided by the original mass of the solute. See text pertaining to this table for explanation of the signs.
^{h}Avg. of multiple trials ranging from 86-97%.

### Example 7

### Solubility Studies with 3 in the Presence of Water

Having determined 3 to be the better solubilizing agent, focus was shifted to developing a standard, optimized treatment. An alternate energy source was tried (Table 3, Entry 2), but microwave (μλ) irradiation did not afford higher solubility. Presuming that an extra hydroxyl group on the phosphite might afford greater solubility owing to increased disruption of hydrogen bonding among the cellulose chains, 4 was investigated as a solubilizing agent. However, 4 revealed a “positive insolubility” (and hence the positive coefficient for the HWT-DDGS mass change in Entry 3 of Table 3. This result is likely to be due to a derivatization and/or adsorption phenomenon involving surfaces of the solids.

The HWT-DDGS used contains approximately 8-10% moisture, which may in part account for its better solubility behavior in 3 than the AFEX-DDGS (see above). It was observed that the addition of 1 mL (0.056 mol, 1.25 eq) of water to 7.14 g (0.044 mol, 1.00 eq) of 3 followed by heating to 100° C. resulted in what appeared to be nearly complete dissolution of the 250 mg of HWT-DDGS (Table 3, Entry 4). Addition of methanol to the reaction mixture followed by filtration showed that 92% of the HWT-DDGS had dissolved, leaving a very small amount of an almost colorless insoluble material (HWT-DDGS and/or derivatized HWT-DDGS) which was weighed. Upon evaporation of the methanol from the filtrate, a viscous yellow residue remained. A 200 mg sample of this residue readily dissolved in 2 mL of water at room temperature. The maximum solubility of this product residue in water has yet to be determined. Decreasing the reaction temperature lowered the solubility (Table 3, Entry 5), while increasing the temperature to 150° C. improved the solubility to nearly quantitative (Table 3, Entry 6). Again, microwave irradiation failed to improve solubility, and the use of 4 with water added to it increased the mass of the insoluble material (Table 3, Entries 7 and 8, respectively). Using 3/H₂O was also effective for solubilizing AFEX and DDG that had not been treated with hot water (Table 3, Entries 9 and 10, respectively). The result with DDG is significant in that no other pretreatment is necessary when using 3/H₂O.

On the basis of the preceding results, it is likely that at least partial hydrolysis of 3 (see Bertrand, R. D., et al., “Stereochemistry of Cage Opening in P(OCH₂)₃CMe Hydrolysis”, 4: 81-89 (1974), which is hereby incorporated by reference in its entirety) occurs to produce an active reagent(s) (Scheme 1) for solubilizing cellulose and starch. When 3 is hydrolized before adding the HWT-DDGS, the solvent properties are the same as when water is combined with 3 and HWT-DDGS at the same time (Table 3, Entry 11). This indicates that hydrolysis of 3 probably occurs faster than its solubilizing action. ³¹P NMR spectroscopic studies demonstrate that in the presence of water, hydrolysis of 3 (δ94 ppm) produces peaks ranging from 12-4 ppm, which is in the phosphonate [O═PH(OR)₂] region of 0-20 ppm (see Tebby, J. C. 1991. Handbook of Phosphorus-31 Nuclear Magnetic Resonance Data, CRC Press, Boca Raton, Fla., which is hereby incorporated by reference in its entirety). On the other hand, a mixture of methanol and 3 displayed no peaks in the phosphonate region (even after heating to 150° C.) and only the 94 ppm peak corresponding to 3 was still present. Since only 1.25 equivalents of water were added to the reaction (Table 3, Entries 10 and 11), it is suspected that most of the phosphite 3 was hydrolyzed to the phosphonate 9 (Scheme 1) and was not completely hydrolyzed to phosphorous acid and trimethylolpropane (Final Hydrolysis Products T in Scheme 3). This point is of some importance, because these results strongly suggest that the phosphite is not merely a source of acid for the well known acid-catalyzed hydrolysis of polycarbohydrates.

To further investigate the role of water, a series of experiments were conducted in which the amount of water and phosphite were varied (see Table 4, below), pure anhydrous phosphorous acid was employed (see Table 5, below, Entry 11). It is important to note that solubility is poor when no or only a catalytic amount of water is added (Table 4, Entries 1 and 4, respectively). Entry 3 shows that a substantial quantity of HWT-DDGS material can be solubilized in the 3/H₂O mixture since the solution formed is 43% w/w in HWT-DDGS based on the weight of phosphite 3. When excess water is used (Entry 5, Table 4), the result is similar to when pure phosphorous acid is employed (Table 5, Entry 11). Thus, the solubility appears to be good but the solution turns black, indicating possibly undesired decomposition. One of the more promising results is shown in Entry 6 of Table 4 where 3 is used in only 50 mol % relative to water, and yet almost complete solubility is observed. This suggests that less phosphite 3 may be necessary while not sacrificing solubility appreciably. This, however, raises the question of whether 10 (the secondary hydrolysis product of 3) may also be a good or even better solubilizing agent. In two solubility experiments with a 1:1 weight ratio of HWT-DDGS:3, where 1 eq of water was added in one experiment and 2 eq in the other trial, no significant difference in solubility was observed. These results imply that the dihydrolyzed species S in Scheme 3 was equivalent in solubilizing action as was R. An approximately equimolar amount of methanol had a measurable effect on the solubility of HWT-DDGS using 3 (Table 4, Entry 7) as opposed to the presence of no added co-solvent (Table 4, Entry 1). The origin of this effect is presently unclear.

TABLE 4
HWT-DDGS Solubility with Varying Amounts of Water in the
Presence of 3.^{a}

| | | H₂O or MeOH | |
|---|---|---|---|
| Entry | Phosphite (g) | (mL) | % Soluble^{h} |
| 1 | 7.14 | 0.00 | 19% |
| 2 | 7.14 | 1.00 | 99% |
| 3 | 0.50 | 0.07 | 86% |
| 4 | 7.14 | 0.08 | 37% |
| 5 | 0.93 | 1.00 | 89%^{c} |
| 6 | 4.50 | 1.00 | 100%^{d} |
| 7 | 7.14 | 1.76 MeOH | 36% |

^{a}All treatments were performed with 250 mg HWT-DDGS heated at 150° C. for 48 h.
^{b}Determined from (weight of insoluble material after methanol extraction)/(initial weight of lignocellulosic material) × 100%.
^{c}10 mol % 3 based on water; reaction mixture turned black.
^{d}50 mol % 3 based on water.

TABLE 5
Screening of Phosphites and Phosphonates with HWT-DDGS.^{a}

| Entry | Phosphite | H₂O or EtOH | % Soluble^{b} |
|---|---|---|---|
| 1 | 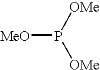 | 1.25 eq | 86% |
| 2 | 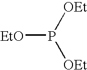 | 1.25 eq | 73% |
| 3 | 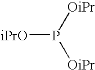 | 1.25 eq | 46% |
| 4 | 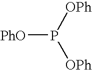 | 1.25 eq | 31% |
| 5 | 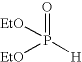 | 0.00 eq | 36% |
| 6 | 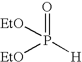 | 1.00 eq EtOH | 63% |
| 7 | 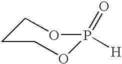 | 0.00 eq | 74% |
| 8 | 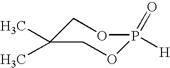 | 0.00 eq | 77% |
| 9 | 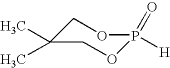 | 1.00 eq EtOH | 77% |
| 10 | 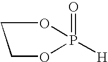 | 0.00 eq | 90%^{c} |
| 11 | H(O)P(OH)₂ | 0.00 eq | 86%^{d} |
| 12 | 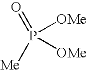 | 0.00 eq | 27% |
| 13 | 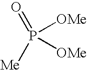 | 1.00 eq | 61% |

^{a}All treatments were performed with 250 mg HWT-DDGS heated at 150° C. for 48 Hrs.
^{b}Determined from: (weight of insoluble material after methanol treatment)/(initial weight of lignocellulosic material) × 100%.
^{c}80° C.
^{d}Solids and solution blackened.

Since adding water improved the lignocellulose solubilizing ability of 3, study of the acyclic phosphites that had earlier revealed poor solubilizing properties by themselves was revisited, in order to investigate the effectiveness of adding water to them. Several phosphonates that resemble compound 5 were examined. Such compounds could prove to be solubilizing solvents that could rival 3/H₂O. The results summarized in Entries 1-4 of Table 5 demonstrate that solubilities were indeed improved by the presence of water, but the solubilities realized were inferior to those achieved with 3/H₂O. The good to excellent solubilities observed with the cyclic phosphonates (Table 5, Entries 7-10) supports the hypothesis that one or more hydrolyzed products of 3 are important in providing high solubilities of lignocellulosic material.

It was observed that the acyclic candidate diethylphosphonate (Table 5, Entry 5) did not provide HWT-DDGS solubility as great as a mixture of triethyl phosphite and 1.25 eq of water (Entry 2), although these solubilizing systems might have been expected to be approximately equivalent solvent systems. However, the hydrolysis of triethyl phosphite also produces ethyl alcohol which was shown to enhance solubilization in the presence of diethylphosphonate (see entries 5 and 6). On the other hand, however, addition of 1 eq of ethanol to 2,2-dimethyl-1,3-propane phosphonate (Entry 9) showed no effect on solubility. It is apparent that these observations comprise a complex phenomenon requiring additional study to understand the role of ethanol in the solubilization using triethyl phosphite. The possibility that the superior solubilization properties of 3/H₂O may be attributed to the hydroxyl group present on a molecule of R (monohydrolized 3 in Scheme 3) should also be investigated. To confirm that phosphite hydrolysis products R and S are not merely sources for phosphorous acid, commercially available phosphorous acid (99% pure crystalline solid) was employed as a solubilizing agent for HWT-DDGS and also for lignin (Entry 11, Table 5, and Entry 9, Table 6, respectively). See Table 6, below. As seen in these entries, phosphorous acid was quite effective in solubilizing HWT-DDGS and it even partially dissolved lignin. However, in both cases, the reactions produced black solutions and black residues. Although this result is not surprising in the case of the lignin experiment (since the lignin used was black-brown), blackening of the tan HWT-DDGS sample is likely due to undesirable decomposition. The alkyl phosphonate ethyldiethylphosphonate in Entry 12 of Table 5 solubilized only 27% of the HWT-DDGS sample, while the same experiment carried out with the addition of 1.00 equiv of water produced 61% solubility (Entry 13), implying that the relatively small solubility observed in Entry 12 might be due to hydrolysis of one of the —OMe ester groups of the alkyl phosphonate by moisture in the HWT-DDGS and/or in the alkyl phosphonate.

TABLE 6
DDGS Model Component Solubility.^{a}

| Entry | Component | Phosphite | Water | Solubility^{b} |
|---|---|---|---|---|
| 1 | Cellulose^{c} | 3 | 1.25 eq | 99% |
| 2 | Cotton | 3 | 1.25 eq | 97% |
| 3 | Cellobiose^{d} | 3 | 1.25 eq | 99%^{j} |
| 4 | Me-Cellobiose^{e} | 3 | 1.25 eq | 99%^{j} |
| 5 | Xylan^{f} | 3 | 1.25 eq | 99% |
| 6 | Lignin^{g} | 3 | 1.25 eq | 99% |
| 7 | Zein^{h} | 3 | 1.25 eq | 99% |
| 8 | Corn Oilⁱ | 3^{k} | 1.25 eq | 31% |
| 9 | Lignin^{g} | H(O)P(OH)₂ | 0.00 eq | 15%^{l} |

^{a}All treatments were performed with 250 mg of component and 44 mmol of phosphite heated at 150° C. for 48 Hrs.
^{b}Determined from: (weight of insoluble material after methanol treatment)/(initial weight of lignocellulosic material) × 100%.
^{c}Chromatography grade from Aldrich
^{d}D-(+)-cellobiose from Aldrich
^{e}Permethylated according to Mendonca and Laine, Carbohydr Res., 2055-59 (2005), which is hereby incorporated by reference in its entirety.
^{f}From oat spelts (Aldrich).
^{g}Indulin AT kraft pine lignin from Westvaco.
^{h}From Aldrich.
ⁱHy-vee salad grade corn oil.
^{j}100° C.
^{k}One g of corn oil:1 g of 3.
^{l}Reaction mixture turned black.

It is interesting to note that the observation of 99% solubility of HWT-DDGS in 3/H₂O is over 60% more than the total 34.5% carbohydrate analysis indicating substantial solubilization of other constituents by 3/H₂O. Since spectroscopic analysis of the complex mixture produced is extremely difficult, some model systems were studied in an effort to elucidate some of the chemistry that was occurring in the solubilization process. To confirm the solubilizing of the cellulose content of HWT-DDGS, cellulose, cotton and cellobiose were examined as substrates. As expected, all gave very good solubilities (Table 6, Entries 1-3). Permethylation of the cellobiose did not effect the solubility (Table 6, Entry 4), suggesting perhaps that glycosidic bond breaking was occurring, further evidence for which will be discussed below. Selectivity for certain carbohydrates is not expected in the process, and this is illustrated by the almost complete dissolution of xylan, another carbohydrate component of HWT-DDGS (Entry 5). As a percentage of the ca 89% dry mass content of DDGS, low molecular weight phenolics make up about 6-7%. Although these materials are not useful for conversion to ethanol, it was shown that pine lignin is also highly soluble in 3/H₂O (Table 6, Entry 6) and, interestingly, the material remaining after methanol extraction and evaporation also was water-soluble. It should be emphasized again that, because of the possibility of reactions involving transesterification with cellulosic OH groups, these phosphites are poised to behave as reactive solvents as well as conventional solvating solvents. The excellent solubility of Zein seen in Entry 7 of Table 6 implies that the protein content of the DDGS is undoubtedly also solubilized. This observation may be important in considering separations downstream. However, any protein phosphitylation that may occur would have to be analyzed for compatibility with livestock if such materials were to be used as a high protein feed additive.

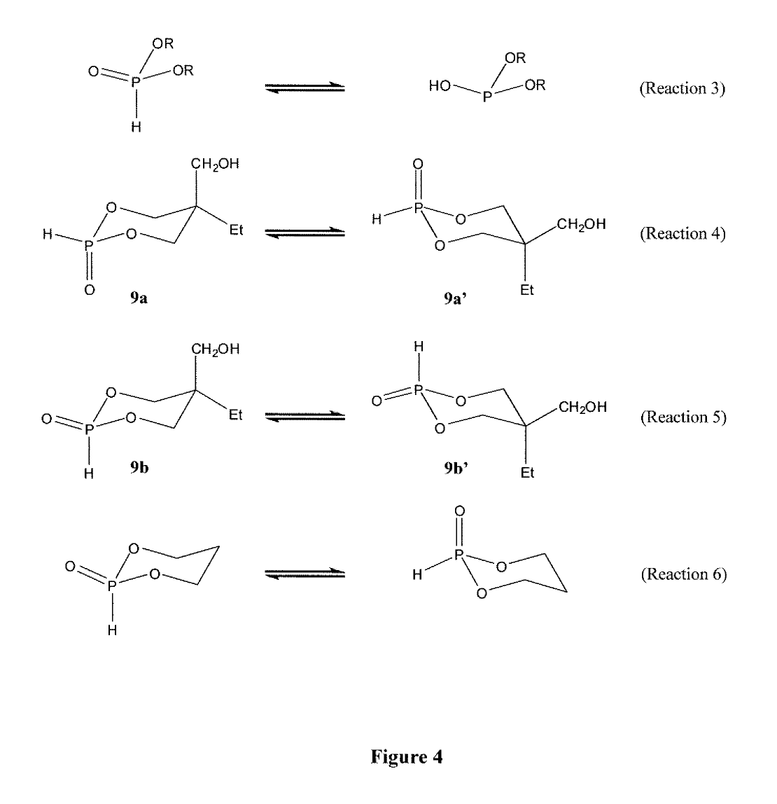

Corn oil (Entry 8 in Table 6) was only 31% soluble in an equal mass of 3/H₂O, and, interestingly, the undissolved corn oil appeared to be decolorized. Since filtration was not a viable option, methanol was added to dissolve polar materials in the reaction mixture, leaving the remaining oil as a separate phase which was then extracted into hexanes. Separation of the hexanes from the methanol solution phase followed by evaporation under reduced pressure of the hexanes extract left a colorless oil containing no phosphorus detectable by P³¹NMR spectroscopy. A H¹NMR spectrum of this oil indicated that the glycerol backbone of the oil had undergone a reaction. It is conceivable that the mildly acidic hydrolysis product R (Scheme 3) facilitates hydrolysis of the triglyceride with the excess 0.25 eq of water to form diglyceride plus free fatty acid. Such hydrolysis could be acid-catalyzed via the phosphite tautomer of R depicted in general form on the right side of reaction 3 in FIG. 4. Indeed, an FT-IR spectrum of the colorless oil revealed an —OH peak that could be attributed to the presence of diglyceride. The free fatty acids liberated during hydrolysis of triglyceride to diglyceride should be soluble in methanol, and this process could account for the 31% solubility of the oil in the 3/H₂O medium, assuming that the refined corn oil used is composed of ca 99% triglycerides. Methanol was removed from the MeOH-soluble portion of the reaction mixture, leaving a viscous yellowish oil that was analyzed by P³¹NMR and H¹NMR spectroscopies. The P³¹NMR spectrum showed phosphorus signals attributable to unreacted R and S in scheme 3, and also multiple minor peaks due to unidentified phosphorus species in the 0-20 ppm range. This range could be associated with various phosphitylated components of the corn oil. The ¹H NMR spectrum corroborated the P³¹NMR spectroscopic results by displaying minor unidentified peaks and high intensity peaks due to the presence of R and S in scheme 3. The fact that there were no phosphorus peaks in the colorless oil extracted into hexanes implies that a value-added usable corn oil co-product might be obtained using the treatment protocol.

It is likely that when a large excess of phosphite 3/H₂O is employed to achieve 99% HWT-DDGS solubility that the oil content will be completely hydrolyzed and, therefore, soluble in methanol. However, in cases such as Entry 3 of Table 4, where lower phosphite:HWT-DDGS ratios are used, the lower solubility encountered could be due, at least in part, to insoluble oil present in the HWT-DDGS. This may be promising since lower mass of phosphite usage is desired from an economical standpoint. Thus, if lower biomass solubility is primarily due to an increase in insoluble materials that do not contain an economically significant source of fermentable sugars, the excess phosphite required to obtain 99% biomass solubility would not be necessary to obtain economically viable yields of fermentable sugars as well as potentially value-added feed product.

An additional potential contributing factor to the solubility of the HWT-DDGS is contained in reaction 3 in FIG. 4 which illustrates the formation of a donor-solvent/additive mixture somewhat analogous to such mixtures referred to in the introduction in which electron-donor solvents (e.g., DMSO) with the additives trifluoroacetic or orthphosphoric acid have been used to dissolve cellulose. See Grinshpan, D. D. B., Novel Processes for Production and Processing of Cellulose Solutions, Editor: Sviridov, B. B. Khimicheskie Problemy Sozdaniya Novykh Materialov I Tekhnologii, 87, Belorusskii Gosudarstvennyi Universitet, Minsk (1998), which is hereby incorporated by reference in its entirety. In the solubilizing solvent system 3/H₂O, each reactant and product in Scheme 1 is an electron pair donor solvent component since each possesses at least three oxygens, each of which bears two lone pairs of electrons. Moreover, 3 features a phosphorus lone pair and the same is true for the tautomers of R, S phosphorous acid because of the well-known tautomeric equilibrium generalized for these species in reaction 3 of FIG. 4. In this equilibrium, the phosphorus atom in the tautomer on the right has an electron lone pair while the one on the left does not. It should be noted, however, that this equilibrium does lie far to the left. It is seen in Schemes 2-4 that each species featuring an O═P—H moiety can exist as an HOP tautomer (see reaction 3 in FIG. 4) that can liberate a proton. The HOP tautomers, therefore, constitute “additives” analogous to the acids mentioned earlier in this paragraph.

### Example 8

### Spectroscopic Studies of Reactions of DDGS with 3

A ³¹P NMR spectrum (in CD₃OD) of the solid residue remaining after evaporation of the methanol extract in the treatment of HWT-DDGS with 3 showed a single peak at 94 ppm corresponding to 3 (in CD₃OD or CD₃Cl). In addition, there were minor peaks between 0-20 ppm, the region in which monoalkyl and dialkyl phosphites typically appear (see Tebby, J. C. 1991. Handbook of Phosphorus-31 Nuclear Magnetic Resonance Data, CRC Press, Boca Raton, Fla., which is hereby incorporated by reference in its entirety). This is consistent with the presence of phosphitylated HWT-DDGS as will be further discussed in the next section. If the methanol had caused significant transesterification of 3 (or of phosphitylated HWT-DDGS) P(OCH₃)₃ would have been formed, with the appearance of a corresponding ³¹P NMR peak at 140 ppm. However, no peaks were observed in this region.

### Example 9

### Spectroscopic Studies of Reactions of DDGS with 3 in the Presence of Water

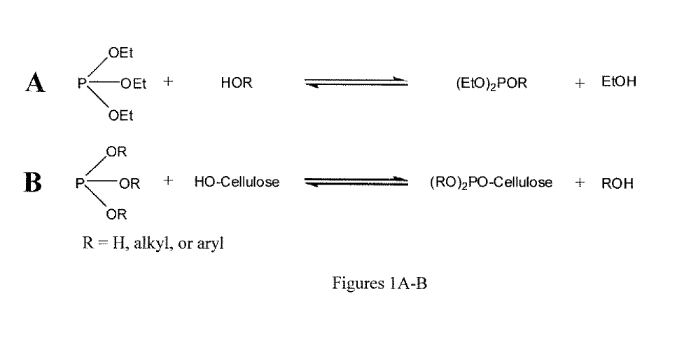

³¹P NMR spectra of product mixtures resulting from treatment of HWT-DDGS with 3 compared with those from the reaction of 3 with 1.00 eq. of water added, and those resulting from treatment with a mixture of 3 and 1.25 equivalents of water, were all complex and quite similar in appearance. However, the latter two reaction mixtures displayed (as expected) no peak at 94 ppm corresponding to 3. Because of similarities among the phosphorus O-alkyl substituents in the hydrolysis products of 3, and in the products of transesterification reactions of R with cellulosic OH groups, it was difficult to distinguish which ³¹P signals corresponded to phosphite species Ra, a′, b, b′ resulting from the conformer/isomer equilibria (see Mosbo, J. A., et al., J. Am. Chem. Soc., 95, (1973), which is hereby incorporated by reference in its entirety) shown in reactions 4 and 5 in FIG. 4, which ³¹P resonance was due to S, and which peaks represented phosphite groups on derivatized HWT-DDGS depicted in FIG. 1B. Thus, 5 and 6 (FIG. 2) were synthesized as model compounds for the first hydrolysis intermediate R in Scheme 3. A ³¹P spectrum of pure 5 in deuterated methanol reveals part of the reason for the complexity of ³¹P NMR spectra of 3/H₂O/cellulosic material mixtures. First, an approximately 5.4 ppm difference in chemical shift is observed between the two phosphorus resonances (12.4 and 7.0 ppm in CH₃OH) assignable to the presence of the two conformers of 5 shown in reaction 6 in FIG. 4. These conformers exist in an equilibrium which is slow on the NMR time scale in CH₃OH but is either fast in CDCl₃, or else this solvent greatly favors one of the conformers where its resonance appears as a single peak at 4.1 ppm. Secondly, deuterium/hydrogen exchange equilibria between the OD deuterium in CD₃OD and the P—H bonds in 5, Ra, a′, b, and b′ in FIG. 4 cause additional ³¹P NMR spectral features to appear owing to P-D spin-spin coupling. Thus, the nuclear spin of 2D is 1 and each ³¹P NMR resonance of 5 appears as a triplet of three equally spaced lines of equal intensity [¹J(³¹P-²D)≈106 Hz]. ³¹P NMR spectra of pure 5 in MeOH with a CDCl₃ lock inserted showed a simple spectrum of only two peaks (12.4 ppm and 7.0 ppm) corresponding to the two conformers shown in reaction 6 of FIG. 4, since P-D spin-spin coupling was necessarily absent. Thirdly, as noted above, the ³¹P NMR spectrum of R (the initial hydrolysis product of 3) gains additional complexity owing to the presence of two conformations in a slow equilibrium with each other for each isomer of R (namely, Ra,a′ and Rb,b′), as shown in reactions 4 and 5 of FIG. 4.

The aforementioned issues also complicated the CD₃OD-solution ³¹P NMR spectra of the viscous product left after evaporation of the methanol extract of 99% HWT-DDGS solubilized in excess 3/1.25 equiv water. In order to enhance the intensity of the phosphitylated HWT-DDGS resonances in the ³¹P NMR spectra, 1.0 g of this material was reacted with 1.0 g of 3 and 0.14 g (1.25 equiv) of water with the aim of reacting all of the phosphite using an excess of HWT-DDGS. About half of the HWT-DDGS was solubilized (0.59 g) not only suggesting that all the phosphite that could be utilized to solubilized the HWT-DDGS had indeed been utilized under the conditions, but also indicating that at least a 50 w/w % solution of HWT-DDGS in an approximately equimolar mixture of phosphite 3 and water could be achieved. The latter pleasing result portends well for potential economical industrial processing using the pretreatment protocol (provided that phosphite can be economically recovered for recycling-see below). A ³¹P NMR spectrum in CH₃OH of the resulting product revealed phosphorus signals from 0-20 ppm, but no peak at 94 ppm for 3. There were multiple peaks (0-20 ppm) as would be expected for such a mixture. Some of these peaks were new, some corresponded to unreacted R, but none could be unambiguously identified as a single derivative. It is clear that considerable additional work is required with components separated from this complex solution of DDGS in order to determine which ones are being derivatized and which are merely being solubilized.

In an attempt to shed further light on the solubilization process of HWT-DDGS by the 3/H₂O protocol, D-(+)-permethylated cellobiose was reacted with 5 (which functioned as a solvent comparable to 3/water for HWT-DDGS) in a 1:1 molar ratio. The virtual absence of hydroxyl groups in 5 (owing to the very minor concentration of the second tautomer) and the unreactivity of 3/H₂O with ether linkages restricts any reaction under the conditions to cleavage of the glycosidic bond of D-(+)-permethylated cellobiose. In addition to ³¹P NMR peaks characteristic of unreacted 5 (12.4 and 7.0 ppm), two additional ³¹P NMR peaks appeared; a major resonance at 11.2 ppm and a minor one at 7.9 ppm. The presence of the major resonance is consistent with glycosidic bond cleavage, since the D-(+)-permethylated cellobiose was determined via FTIR spectral analysis to contain no significant amount of free —OH groups or water. The minor peak ³¹P NMR at 7.9 ppm is thought perhaps to be due to reaction of 5 with free —OH impurities owing to incomplete methylation of cellobiose in concentrations sufficiently low to be undetectable by FTIR spectroscopy.

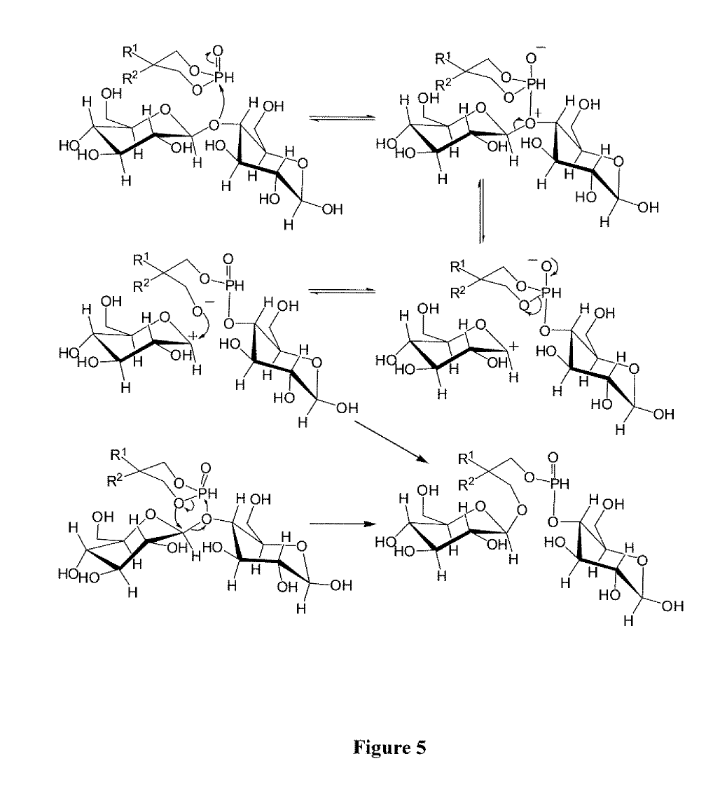

The ³¹P NMR spectra of the reaction product of HWT-DDGS with 3/H₂O mixtures (which presumably produced R) also exhibited peaks in the 11 ppm region consistent with glycosidic bond cleavage. Because the glycosidic linkage is quite robust, it was inferred that there might be evidence in the ³¹P NMR spectra of the esterification product stemming from reaction of POH/[P(O)H] tautomeric groups in 5 and in R with one or more different cellulose OH groups in the DDGS to give 8. As stated earlier, however, ³¹P NMR chemical shifts between 75-162 ppm typical for such phosphite esters were not observed. It was then conjectured that glycosidic bond cleavage arose via acid-catalysis by phosphorous acid formed via hydrolysis in DDGS/3/H₂O reactions. Such hydrolysis can also be ruled out, however, at least in the reaction of 5 with D-(+)-permethylated cellobiose mentioned above, since there are peaks in the ³¹P NMR spectra of the reaction products (4-13 ppm) which are consistent with the formation of new dialkyl phosphonate species (−2.5 to +22.5 ppm). Moreover, no water is present in the reaction, which would be required for hydrolysis of the D-(+)-permethylated cellobiose. On the basis of these arguments, it is believed that glycosidic linkages are cleaved, and a plausible mechanism is shown in FIG. 5. Nucleophilic attack on the phosphorus by the glycosidic oxygen lone pair [analogous to acetate oxygen attack of a dialkylphosphonate] facilitates cleavage of the glycosidic bond to produce a six-membered ring carbocation of one glucose unit that is known to occur during acid-catalyzed hydrolysis (see Xiang et al., Appld. Biochem and Biotech., 105-108: 505-514 (2003), which is hereby incorporated by reference in its entirety). Subsequent equilibrium reactions eventually allow the ring of the cyclic dialkyl phosphonate to open and the resulting oxyanion could then attack the cyclic carbocation to give a dialkylphosphite bonded to two glucose acetals, as shown in FIG. 5. It is also conceivable that a four-membered ring intermediate is formed as shown in FIG. 5, despite increased steric congestion that could be involved.

Although phosphorous acid may play a partial role, the observation that 3 appears to be a better solvent for DDGS than 2 or 4 indicates that the bicyclic phosphite does not simply serve as a source of phosphorous acid in the presence of water. Supportive of this view is the apparent decomposition observed with phosphorous acid (Entry 5 of Table 4, Entry 11 of Table 5, and Entry 9 of Table 6) compared with the results obtained with a mixture of 3/H₂O. It is also interesting that an analogous mixture of 4/H₂O did not provide good solubility despite the presence of the extra OH group which was originally postulated to enhance the ability of 4 to hydrogen bond with water or methanol. In fact, the use of 4 led to a significant increase in the mass of the insoluble portion of the HWT-DDGS, presumably because of derivatization.

It is believed that R (which is formed first via hydrolysis of 3 in Scheme 3) acts as an active phosphitylating/solubilizing agent. Therefore, it is not necessary to completely remove the water from the light stillage. Indeed, it has been observed that un-pretreated Distillers Grains (DG) which has a significant moisture content, showed good solubility (Table 3, Entry 10).

### Example 10

### Solvent/Reactant Recovery Reactions of DDGS with 3

Compound 3 is an easily sublimable solid. After evaporation of the methanol extract of the reaction mixture produced by heating DDGS in 3, approximately 67% of 3 was recovered. Recovery of additional 3 should be possible since the ³¹P NMR spectrum of the residue remaining after sublimation displayed a prominent peak for 3. There has been some success in recovering unreacted 3 by ether extraction. However, the ether layer also contained other phosphorus-containing species as indicated by ³¹P NMR spectroscopy, and their identities are presently unclear. In addition, the ether-insoluble portion also revealed the presence of a significant amount of 3 via ³¹P NMR spectroscopy.

### Example 11

### Solvent/Reactant Recovery Reactions of DDGS with 3 in the Presence of Water

As noted earlier, a reaction mixture of 3 and water upon heating produces EtC(CH₂OH)₃ and (O)HP(OH)₂ in an equilibrium reaction. Phosphite 3 can be partially regenerated by elimination of water upon heating in the presence of a catalytic amount of triethylamine. Initial efforts at recovering 3 by distillation/sublimation from the aforementioned product mixture were difficult, because 3 seems to co-distill with water, giving a distillate consisting of a mixture of 3 and hydrolysis products R and S. However, this does not pose a major concern since the distillate could be recycled.

It is also conceivable that the poorer solubilization properties of acyclic phosphites relative to 3 could be offset by their lower cost. It is clear that downstream testing with different enzymatic saccharification protocols with subsequent or simultaneous fermentation will be necessary to determine the optimum solubilizing system by weighing solubility performance, sugar yield, phosphite recoverability demands/limits, costs associated with materials and energy required. It may even be the case that some systems that provide poorer solubility using lower temperatures or employing a phosphite other than 3 would be more compatible with downstream processing into ethanol and/or other products, based on potential selectivity in the compounds that may be solubilized/derivatized.

### Example 12

### Solubility of Lignocellulosics

All reactions were carried out at 100° C. using 0.44 mmols of phosphite and 250 mg of solute. After the reaction was over, the workup procedure was the same as described above. Distillers Grains (which still contained >40% moisture) were dried and ground (to 0.5 mm particles). See Table 7, below.

TABLE 7

| | | | Time | “Solubility” |
|---|---|---|---|---|
| Entry | “Solvent” | Solute | (days) | % by wt |
| 1 | P(OCH₂)₃CEt/H₂O | DG | 1 | 78 |
| 2 | P(OMe)₃/H₂O | HWT-DDGS | 2 | 82 |
| 3 | P(OEt)₃/H₂O | HWT-DDGS | 2 | 52 |
| 4 | P(O-i-Pr)₃/H₂O | HWT-DDGS | 2 | 48 |
| 5 | P(OPh)₃/H₂O | HWT-DDGS | 2 | 31 |
| 6 | H(O)P(OEt)₂ | HWT-DDGS | 2 | 30 |
| 7 | H(O)P(OCH₂)₂CMe₂ | HWT-DDGS | 2 | 77 |
| 8 | H(O)P(OCH₂)₂CH₂ | HWT-DDGS | 2 | 74 |
| 9 | P(OCH₂)₃CEt/H₂O | Corn Stalk | 2 | 54 |
| | | (whole) | | |
| 10 | P(OCH₂)₃CEt/H₂O | Corn Stalk with | 2 | 52 |
| | | the pith removed | | |
| 11 | P(OCH₂)₃CEt/H₂O | Synthetic | 2 | 67 |
| | | Melanin | | |

### Example 13

### Solubilization of Melanin

The procedure was carried out at 130° C. using 500 mg (3.1 mmols) of phosphite, 0.07 mL (3.8 mmols, 1.25 equivalents) water, 50 mg of synthetic melanin (purchased from Aldrich), and a small octagonal magnetic stir bar, all of which were charged to a 20 mL pressure tube. The tube was sealed with a Teflon cap, and submersed in a 130° C. oil bath in order to ensure even heating of the tube and its contents and to avoid sublimation of the phosphite to cooler parts of the tube. The mixture was stirred for 48 hrs and then it was allowed to cool to room temperature whereupon 15 mL of methanol was added. Once the phosphite and undissolved melanin were equilibrated with the methanol, the solids were filtered and weighed, revealing that 67% of the synthetic melanin by weight had dissolved and/or had been derivatized. Evaporation of the methanol filtrate gave a residue that was soluble in water. See Entry 11, Table 7, above.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method of solubilizing melaninic, ligninic, chitinic, and/or cellulosic material comprising:
providing melaninic, ligninic, chitinic, and/or cellulosic material;
providing an oxoacid ester of phosphorus or a mixture of an oxoacid of phosphorus and an alcohol;
forming a blend of the melaninic, ligninic, chitinic, and/or cellulosic material, the oxoacid ester of phosphorus or the mixture of the oxoacid of phosphorus and alcohol; and
treating the blend under conditions effective to solubilize the melaninic, ligninic, chitinic, and/or cellulosic material.

2. The method of claim 1, wherein the oxoacid ester of phosphorus is provided.

3. The method of claim 1, wherein the mixture of the oxoacid of phosphorus and the alcohol is provided.

4. The method of claim 1, wherein the melaninic, ligninic, chitinic, and/or cellulosic material is fully solubilized as a result of said treating.

5. The method of claim 1, wherein the melaninic, ligninic, chitinic, and/or cellulosic material is partially solubilized as a result of said treating.

6. The method of claim 1, wherein the melaninic, ligninic, chitinic, and/or cellulosic material is lignocellulosic material.

7. The method of claim 6, wherein the lignocellulosic material is selected from the group consisting of wood fiber, vegetable fiber, and mixtures thereof.

8. The method of claim 1, wherein the melaninic, ligninic, chitinic, and/or cellulosic material is ligninic material.

9. The method of claim 1, wherein said treating is carried out at a temperature of 60-150° C.

10. The method of claim 1, wherein said treating is carried out at a temperature of 75-110° C.

11. The method of claim 2, wherein the oxoacid ester of phosphorus is selected from the group consisting of esters of phosphorous acid, phosphoric acid, hypophosphorous acid, polyphosphoric acid, and mixtures thereof.

12. The method of claim 3, wherein the oxoacid of phosphorus is selected from the group consisting of phosphorous acid, phosphoric acid, hypophosphorous acid, polyphosphoric acid, and mixtures thereof.

13. The method of claim 3, wherein the alcohol is selected from the group consisting of methanol, ethanol, ethylene glycol, propylene glycol, glycerol, pentaerythritol, trimethylol ethane, trimethylol propane, trimethylol alkane, alkanol, polyol, and mixtures thereof.

14. The method of claim 3, wherein the blend has a ratio of the oxoacid of phosphorus to the alcohol of from 10:1 to 1:10.

15. The method of claim 1 further comprising:
regulating the water content of the blend during said treating.

16. The method of claim 15, wherein said regulating the water content comprises removing water.

17. The method of claim 16, wherein said removing water comprises molecular sieving.

18. The method of claim 16, wherein said removing water comprises distillation.

19. The method of claim 16, wherein said removing water comprises adding a dehydrating agent to the blend.

20. The method of claim 1 further comprising:
adding an enzyme to the blend after said treating.

21. The method of claim 20, wherein said enzyme is a cellulase.

22. The method of claim 1 further comprising:
sonicating the blend during or after said treating.

23. The method of claim 1 further comprising:
adding a fermentation agent to the blend after said treating.

24. The method of claim 23 further comprising:
fermenting soluble monosaccharides, oligosaccharides, polysaccharides, heteropolysaccharides, and/or sugar alcohols in the blend after said treating.

25. The treated blend of the method of claim 1.

26. The fermented, treated blend of the method of claim 24.

27. A composition comprising solubilized organophosphorous ester derivatives of melaninic, ligninic, chitinic, and/or cellulosic material.

28. A hydrolysis method comprising:
providing the composition of claim 27;
providing an enzyme; and
treating the composition with the enzyme under conditions effective to hydrolyze the composition.

29. The method of claim 28, wherein the enzyme is cellulase.

30. A fermentation method comprising:
providing the composition of claim 27;
providing a fermentation agent; and
treating the composition with the fermentation agent under conditions effective to ferment the composition.

31. The method of claim 28, wherein the fermentation agent is a yeast.
